(19) United States
(12) Patent Application Publication
(10) Pub. No.: US 2007/0063361 A1
(43) Pub. Date: Mar. 22, 2007

(54) Method and system for recovering vapor exhaust from processing equipment

(76) Inventor: Bonnie Palmer, Port Arthur, TX (US)

Correspondence Address: Darrell Walker, Attorney, Suite 250, 9301 Southwest Freeway, Houston, TX, 77074, US

(21) Appl. No.: 11/523,318

(22) Filed: Sep. 19, 2006

Related U.S. Application Data
(60) Provisional application No. 60/718,495, filed on Sep. 19, 2005.

(51) Int. Cl. B01F 3/04; B01D 47/06

(52) U.S. Cl. 261/115; 261/DIG. 11

(57) ABSTRACT

The present cooling tower vapor recovery system recycles the steam/vapors emitted from the cooling tower thereby substantially reducing vapors containing toxins from entering the atmosphere and adding to the pollution. In this system, a cover is positioned over the cooling tower cells. The cover traps the vapor. Fans positioned in a drain create a vacuum that pulls the trapped vapors downward toward the bottom of the cooling tower. As the vapor travel downward, they condense and become water. This water enters the basin with the water that is used during cooling tower operations. This recycling process results in reduced corrosive effects on nearby buildings, piping and other facilities. As a result, the implementation of the present invention provides safe, timely and cost effective maintenance.

### CROSS REFERENCE TO RELATED APPLICATIONS

This application claims priority from provisional application No. 60/718,495 filed on Sep. 19, 2005 and incorporates herein the contents thereof.

### FIELD OF THE INVENTION

The present invention relates to a vapor recovery system that is implemented in a cooling tower device and more particular the present invention relates to a vapor recovery system implemented in a cooling tower devices in which the vapors emitted from the cooling towering are trapped and channeled back through the cooling tower before the vapors are able to escape into the atmosphere.

### BACKGROUND OF THE INVENTION

Processing plants implement cooling systems to keep the equipment and facilities cool in an environment where temperatures of the processing equipment can be quite high. Cooling towers perform this cooling function. There are several different ways that water is used in air conditioning. The most common use is in cooling towers. A cooling tower can be any size, from really gigantic down to the size of an automobile.

In a cooling tower, air blows over water to create evaporative cooling, and this cooler water is used in the heat exchanger of, say, an air conditioner. A more direct form of evaporative cooling is often found in greenhouses, farmers' markets and chicken houses. In these kinds of systems, water flows over a mesh, and a fan blows air through the wet mesh into the building. Humid, cooler air is the result.

Water is the most commonly used medium for removing heat from industrial equipment. Water has excellent heat transfer capability, which is reversible so that the water can be cooled and reused. Typically, water is recycled by the use of a cooling tower, which allows a portion of the water to be evaporated. Since water is rarely pure, contaminants in the water are concentrated during the evaporation process. Concentration of the contaminants leads to multiple problems such as scaling, corrosion and fouling by algae, bacteria, and fungi, the treatment of which require the use of chemicals and/or frequent maintenance.

In the past, water was typically treated with chemical conditioners to control scaling, corrosion and biofouling. Chelators and complexers were added to control the formation of scale, inhibitors were added to control corrosion, and biocides were added to control biofouling. In addition to the foregoing, other additives, such as buffers and pH control additives are frequently used. The use of these chemicals adds expense, increases effort to monitor and maintain appropriate chemical levels, and creates disposal problems. Non-chemical systems have been developed, such as magnetic systems and ozone generators, but these have proven to be expensive and, at best, only marginally effective. Ozone systems, for example, have a beneficial effect on the control of biofouling, but have a limited effect on the control of scale formation and corrosion protection.

FIG. 1 shows a standard three cell cooling tower 10 in a normal operation emitting steam/vapors 11 into the atmosphere. The tower contains three cells 16 each having a fan (12, 13, 14) that causes the vapors to be emitted into the atmosphere. When the steam/vapors 11 are emitted from the tower cool, they become heavy and fall to the ground. A basin 15 at the bottom of the cooling tower contains water that is used during the cooling tower operations. Steps 17 are shown that can be used for maintenance personnel to access the tower. The emitted steam/vapors contain many chemical such as chromate, chlorine and soda ash which are all pollutants and harmful to health. An additional disadvantage to this operation is poor visibility and corrosive effect of anything, which come in contact with the steam/vapors.

There remains a need for a vapor recovery system that can prevent the emission of cooling tower vapors containing toxic chemicals and other pollutants into the atmosphere.

### SUMMARY OF THE INVENTION

The present invention provides a vapor recovery method and system. In this system, a cover is positioned over the cells of the cooling tower. This cover traps the emissions (usually steam). These emissions typically contain toxins and other chemicals that can pollute the air. One or more fans positioned in a drain create a suction effect and draws the trapped emissions down. As the emissions travel down the drain, they cool, condense and become water. A basin at the bottom of the cooling contains water that is used in the cooling tower operations. The condensed water traveling down the cooling flows into the basin and is again used in the cooling tower operations.

The present invention provides significant advantages over the current systems. With the system of the present invention, recycling the steam/vapors will substantially reduce problems with visibility. This reduction in visibility problems will reduce the possibility of lawsuits and liability. Also recycling would save money on the cost of plant operations. The chemicals in the steam/vapors return to the basin of the cooler instead of the atmosphere resulting in little corrosive effects on nearby buildings, piping and other facilities. As a result, the implementation of the present invention provides safe, timely and cost effective maintenance.

### DESCRIPTION OF THE DRAWINGS

FIG. 1 shows a conventional cooling system.

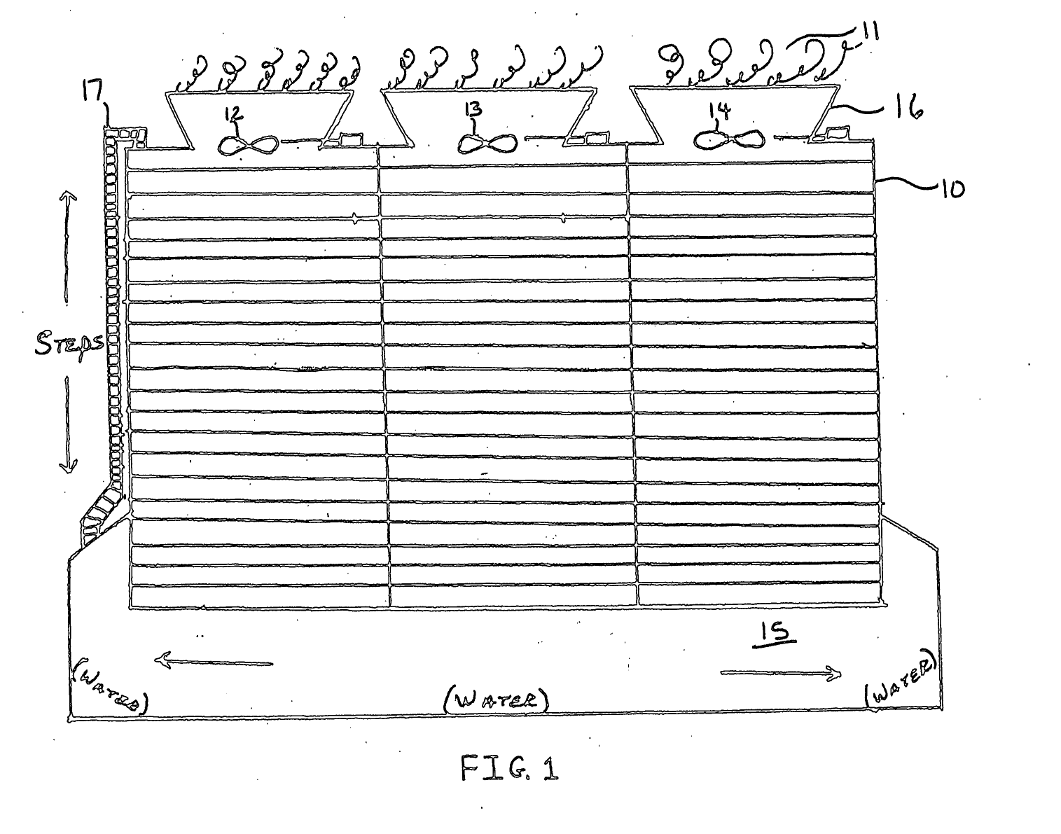

FIG. 2 is an implementation of the vapor recovery system of the present invention.

FIG. 3 is an alternate embodiment of the vapor recovery system of the present invention.

FIG. 4 is an embodiment of the present invention implementing a fan and a motor.

FIGS. 5a and 5b illustrate a cover embodiment of the present invention.

FIGS. 6a and 6b illustrate an alternate embodiment of the cover of the present invention.

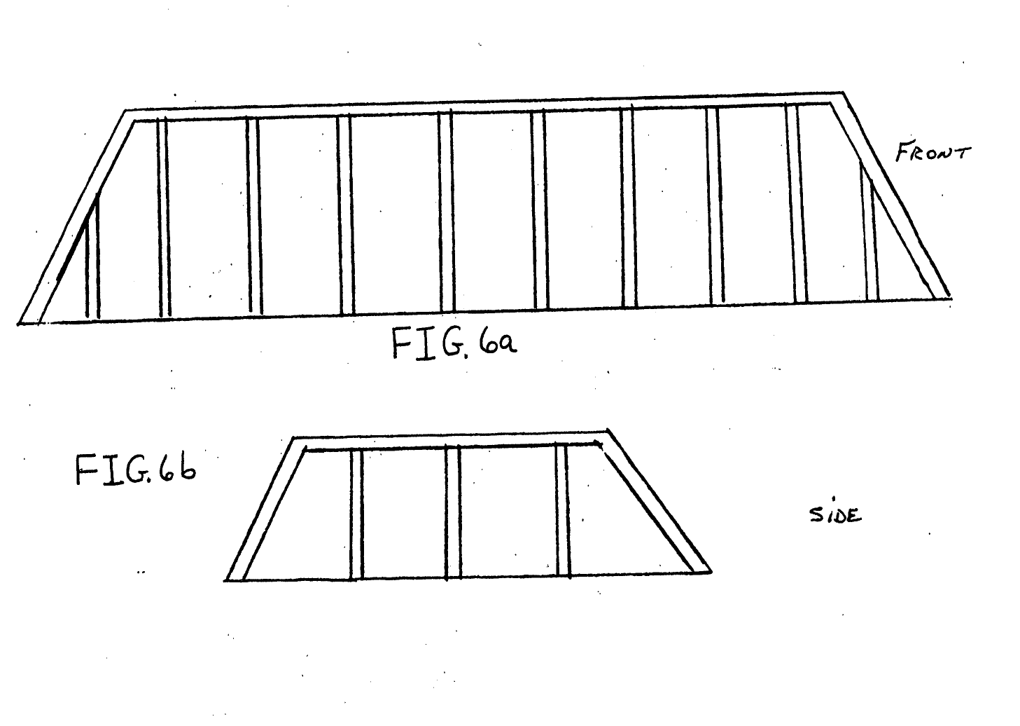

### DESCRIPTION OF THE INVENTION

The present invention provides a cooling tower system that comprises a cover over the cooling tower that serve to substantially block emissions (vapors) from the tower that normally escape into the atmosphere. These vapors contain chemicals that can be harmful to the environment and to individuals. As these contact the cover, they condense into a liquid form. This liquid is then channeled down to the bottom of the tower and recycled as water/liquid back through the cooling cycle of the tower. The following drawings illustrate the structure and function of the present invention implemented in a cooling tower system.

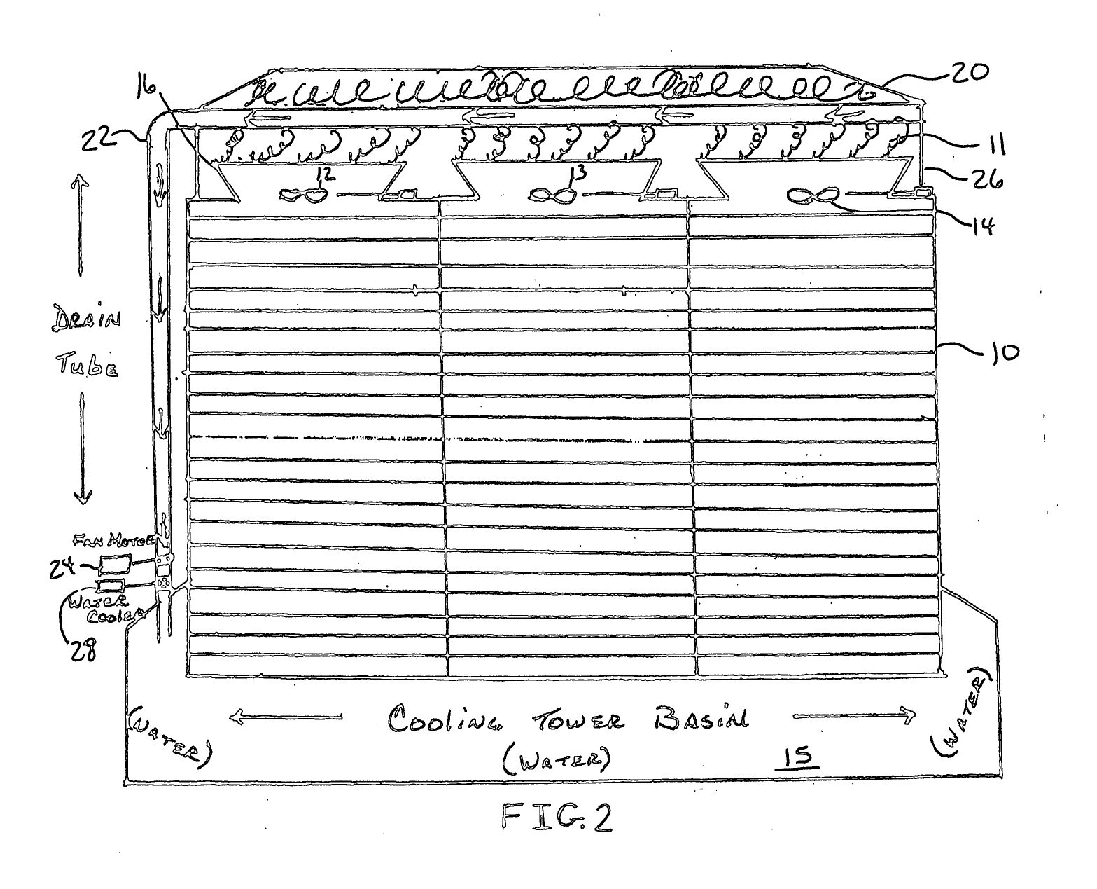

FIG. 2 shows the cooling tower used in the vapor recovery system of the present invention. The vapor recovery cover 20 positioned above the cooling tower shrouds 16 is on stilts 26 that raise the system above the shrouds catching all the vapors 11 before they enter into the atmosphere. The fan motor 24 creates a suction that draws the emitted vapors down the drain tube 22 and into the basin 15. As the vapors travel down the drain tube, they cool, condense and become water as they enter the basin 15. A water-cooling device 28 can be incorporated into the drain tube to facilitate the cooling process. When in the basin, the recycled water is again used in the cooling tower operations.

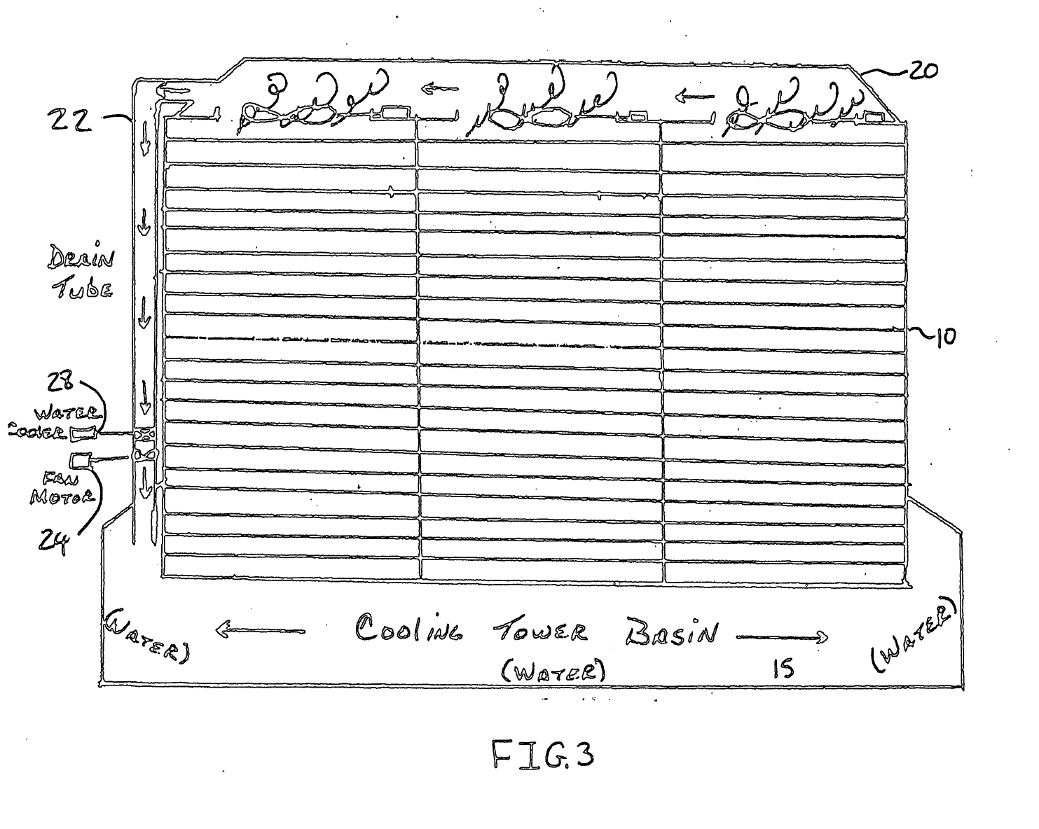

FIG. 3 shows the vapor recovery system of the present invention lowered to the deck of the cooling tower. This cover design 20 creates a totally closed recovery system. Notice the three shrouds have been taken away which is cost effective and creates a sleek and universal look. The steam/vapors are captured directly in the vapor recovery system and transferred to the basin 15.

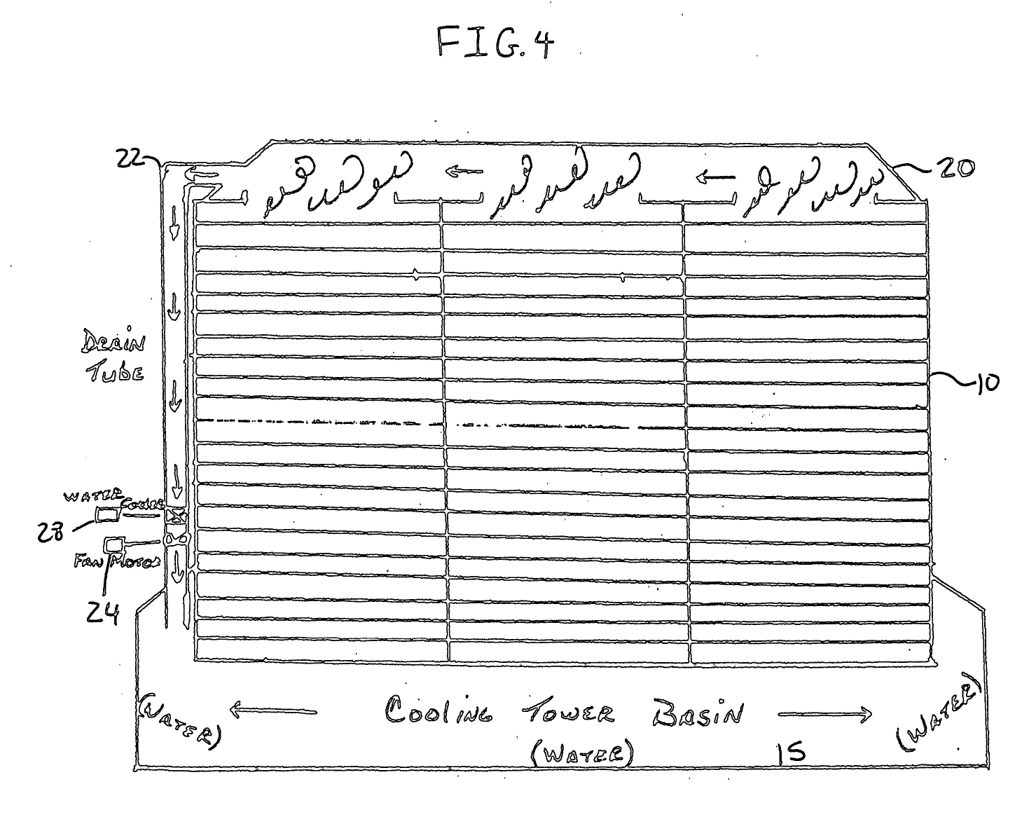

FIG. 4 shows the vapor recovery system of the present invention lowered to the deck of the cooling tower. Notice not only are the shrouds not there but also the top fans have been taken away leaving one water cooler and one fan inside the drain tube which is even more cost effective along with an aerodynamic appearance.

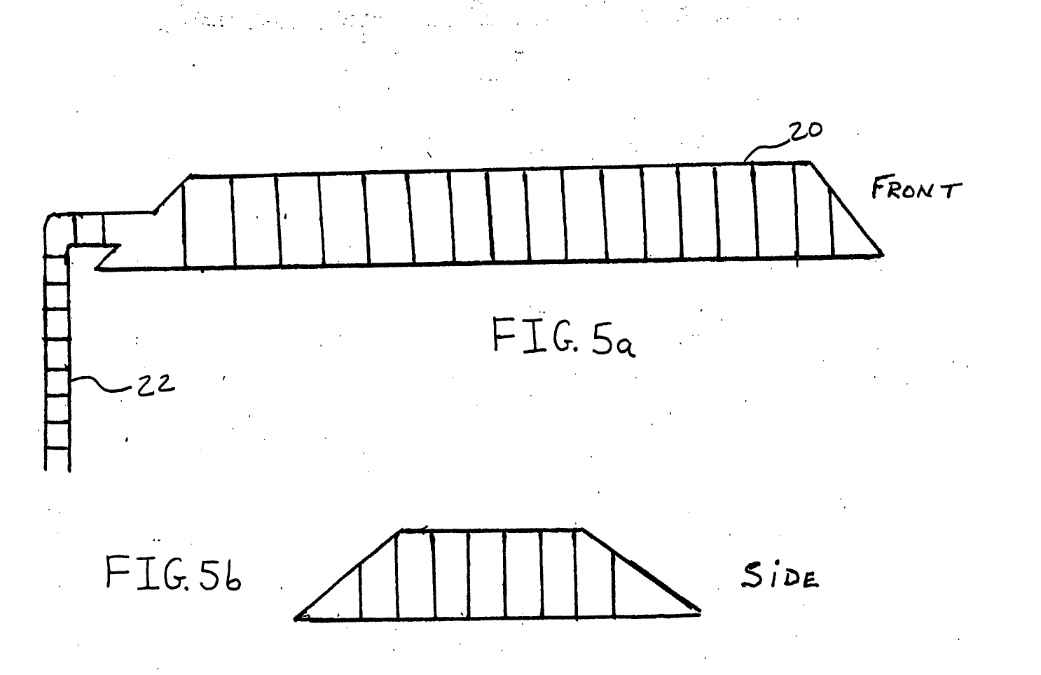

FIG. 5 shows the cover of the vapor recovery system. The construction of the cover is of the same material as existing shrouds (fiberglass). Fiberglass has many advantages such as: 10 it is lightweight, it is non-corrosive and it last for many years. Because the vapor recovery system is constructed in panels secured with nuts and bolts, should the need arise to change a section it could be done in a safe, timely and cost effective manner.

The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A cooling tower vapor recovery system comprising:
a cooling tower having a top and a bottom and having a basin at the bottom the cooling contain liquid for use in the cooling tower operations and a shroud for emitting vapors from the top of the cooling tower;
a cover attached to the top of the cooling for trapping the emitted vapors and substantially preventing the vapors from escaping into the atmosphere;
a drain tube connected to and extending from the top of the cooling to the basin at the bottom of the cooling tower, the drain tube connected to the cover such that emitted vapors can flowing to the drain tube; and
a fan incorporated into the drain tube capable of creating a suction that causes the emitted vapors to be drawn into and down the drain tube into the basin.
